(19) United States
(12) Patent Application Publication
(10) Pub. No.: US 2017/0120304 A1
(43) Pub. Date: May 4, 2017

(54) WIRELESS CONTROLLED WATERBLASTING SYSTEM

(71) Applicant: Federal Signal Corporation, Oak Brook, IL (US)

(72) Inventor: John Bolling Schaer, III, Chappell Hill, TX (US)

(21) Appl. No.: 15/336,263

(22) Filed: Oct. 27, 2016

Related U.S. Application Data
(60) Provisional application No. 62/248,694, filed on Oct. 30, 2015.

(51) Int. Cl. B08B 3/02; H04W 4/00; G05B 15/02; B05B 7/24; B05B 12/00

(52) U.S. Cl. CPC B08B 3/02; B05B 7/24; B05B 12/00; G05B 15/02; H04W 4/008

(57) ABSTRACT

A waterblasting system includes a fluid supply device, an air supply device, and a waterblasting tool. The waterblasting system further includes a wireless controller providing an interface for an operator to wirelessly control both the fluid supply device and the air supply device. The wireless controller can actuate an engine of the fluid supply device and a valve unit of the air supply device to control a pressurized fluid from the fluid supply device and a compressed air from the fluid supply device, which are delivered to the waterblasting tool.

### CROSS-REFERENCE TO RELATED APPLICATION

This application claims the benefit of provisional application Ser. No. 62/248,694, filed Oct. 30, 2015, which is incorporated herein by reference in its entirety.

This application relates to the U.S. Provisional Patent Application (Attorney Docket No. 15727.0051USP1) titled WATERBLASTING SYSTEM WITH AIR-DRIVEN ALTERNATOR, filed on the same day as the present patent application, the entirety of which is hereby incorporated by reference.

### BACKGROUND

In various waterblast industries, waterblasting systems are used to direct a high pressure blast of fluid, such as water, against various surfaces such as concrete, metal, and the inside of tubes and vessels to clean unwanted deposits therefrom or to cut the materials. Such fluid jet stream can have a pressure in the range of 5,000 to 40,000 psi.

Waterblasting systems typically involve several safety precautions because the systems are designed to spray high velocity streams of compressed air, fluids, and/or abrasive particles on a surface. A misdirected blast jet stream can cause severe harm to an operator. Therefore, an operator must keep proper control of the waterblasting system and ensure that the operator's extremities are out of harm's way.

Waterblasting systems include a control station that the operator actuates to control an associated waterblasting system. The control station is typically connected to the waterblasting system via hydraulic or pneumatic tubes. Since the control station is an immovable structure around the waterblasting system, the operator needs to stay around the waterblasting system to manipulate the control station. Therefore, the operator of the waterblasting system remains exposed to harm and danger while the waterblasting system operates nearby.

### SUMMARY

In general terms, this disclosure is directed to a wireless controlled waterblasting system. In one possible configuration and by non-limiting example, the system includes a fluid supply device and an air supply device that deliver pressurized fluid and air to a waterblasting tool, respectively, and are controlled using a wireless controller. Various aspects are described in this disclosure, which include, but are not limited to, the following aspects.

One aspect is a waterblast system including a waterblast tool, a fluid supply device, an air supply device, and a wireless controller. The fluid supply device is configured to provide pressurized water to the waterblast tool. The air supply device is configured to provide compressed air to the waterblast tool. The wireless controller is connected to the fluid supply device and the air supply device via network. The wireless controller is configured to receive a user input for controlling the fluid supply device and the air supply device. In certain examples, the network includes a wireless local area network.

In certain examples, the wireless controller includes a mobile computing device, the mobile computing device running an application that provides an interface for a user to provide the user input.

In certain examples, the fluid supply device includes a fluid pump, an engine adapted to operate the fluid pump, a communication device configured to wirelessly communicate with the wireless controller and receive at least part of the user input from the wireless controller, and a control device configured to control the engine based on the at least part of the user input.

In certain examples, the air supply device includes an air preparation and power unit providing pressurized air and generating electric power, and a valve unit pneumatically and electrically connected to the air preparation and power unit. The valve unit is configured to communicate with the wireless controller and control air flow to the waterblast tool based on at least part of the user input received from the wireless controller. The valve unit can include a communication device configured to wirelessly communicate with the wireless controller and receive at least part of the user input from the wireless controller, and one or more valves controlling flow of the pressurized air to the waterblast tool based on the at least part of the user input.

The above features and advantages and other features and advantages of the present teachings are readily apparent from the following detailed description for carrying out the present teachings when taken in connection with the accompanying drawings.

### BRIEF DESCRIPTION OF THE DRAWINGS

FIG. 1 schematically illustrates a waterblast system in accordance with an example embodiment of the present disclosure.

FIG. 2 schematically illustrates a fluid supply device of the waterblast system of FIG. 1.

FIG. 3 illustrates an example implementation of the fluid supply device of FIG. 2.

FIG. 4 is an example configuration of a control device of the fluid supply device of FIG. 2

FIG. 5 schematically illustrates an air supply device of the waterblast system of FIG. 1.

FIG. 6 schematically illustrates a valve unit of the air supply device of FIG. 5.

FIG. 7 is an example implementation of the valve unit of FIG. 6.

FIG. 8 schematically illustrates an air preparation and power unit of the air supply device of FIG. 5.

FIG. 9 illustrates an exemplary architecture of a computing device that can be used to implement aspects of the present disclosure.

### DETAILED DESCRIPTION

Various embodiments will be described in detail with reference to the drawings, wherein like reference numerals represent like parts and assemblies throughout the several views.

In general, the waterblasting system in accordance with the present disclosure includes a fluid supply device, an air supply device, and a waterblasting tool. The waterblasting system further includes a wireless controller providing an interface for an operator to control both the fluid supply device and the air supply device. In certain examples, the wireless controller can also be used to control the waterblasting tool. In certain examples, the wireless controller is connected to the fluid supply device and the air supply device via a wireless local area network, and configured to control an engine of the fluid supply device and a valve unit of the air supply device, thereby controlling a pressurized fluid from the fluid supply device and a compressed air from the fluid supply device, which are delivered to the waterblasting tool.

The waterblasting system of the present disclosure allows a user to actuate and control both of the fluid supply device and the air supply device using the wireless controller while being remotely present from the fluid supply device and the air supply device. Therefore, the user is not exposed to a pressurized fluid from the fluid supply device 102, a compressed air from the air supply device 104, and a blast jet stream from the tool 106, thereby preventing harm and danger that may result therefrom.

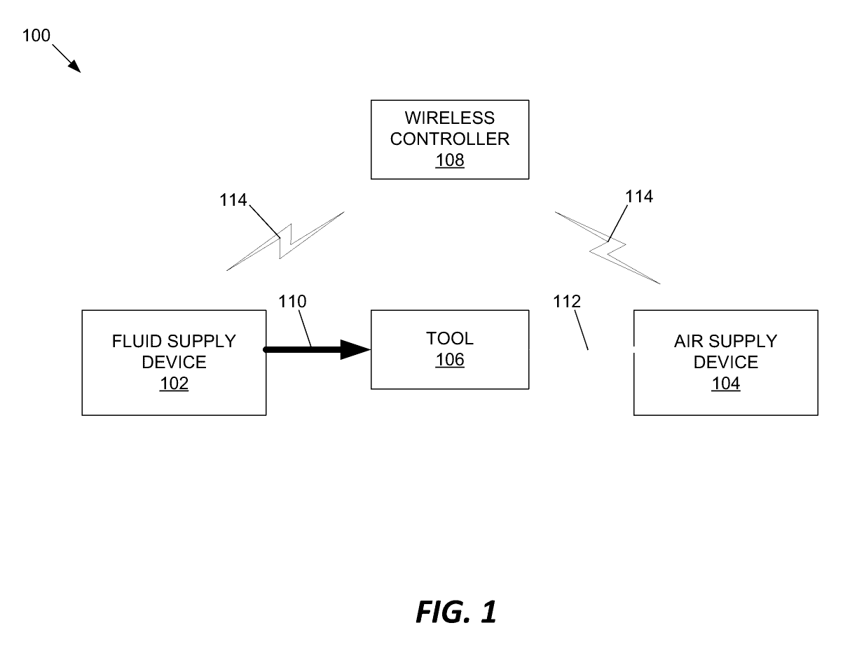

FIG. 1 schematically illustrates a waterblast system 100 in accordance with an example embodiment of the present disclosure. The waterblast system 100 includes a fluid supply device 102, an air supply device 104, a waterblast tool 106, and a wireless controller 108.

The waterblast system 100 can be used in various applications, such as abrasive water jet cutting, hydrodemolition, pipe cleaning, surface preparation and cleaning, tank or vessel cleaning, tube cleaning, and oil field cleaning. For example, the waterblast system 100 is configured for abrasive water jet cutting, which is to slice into metal or other materials using a jet of water at a high velocity and pressure, or by using a mixture of water and an abrasive substance. Hydrodemolition is a process for removing or repairing concrete on various constructions (e.g., roadways and bridges) and elevated parking structures. High-pressure water blasting tools are used to remove concrete while maintaining structural integrity and preserving rebar in the process. For surface preparation and cleaning, the waterblast system 100 is configured to clean a surface using high pressure water blasting. For example, the waterblast system 100 can eliminate rust, old coatings, product residue, or damages concrete prior to re-pouring. The waterblast system 100 can also be used in a variety of industries for process, storage, and transportation of materials, such as reactors, tank trucks, railcars, barges, and ship cargo tanks. In some embodiments, a three-dimensional tool can be dropped into the tank or vessel, and high pressure water is injected through the tool to clean the interior of the entire tank or vessel. For tube cleaning, the waterblast system 100 provides high pressure water to clean unwanted deposits that build up in tubes, heat exchangers, boilers, fin fans, and piping systems. For oil field cleaning, the waterblast system 100 is configured to clean and remove drilling mud and cement from drill pipe, remove paraffin and crude residues on platforms and storage tanks, remove rust and varnish prior to recoating, clean dope and oil from pipe threads for inspection, clean drill pipes that are used for down hole drilling.

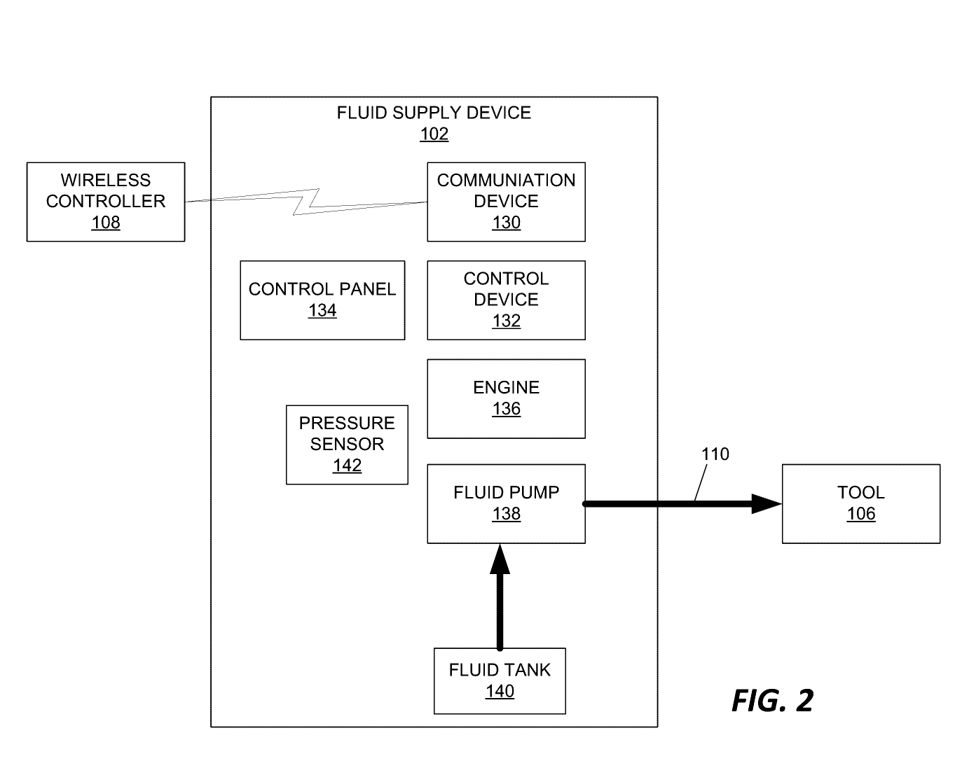

The fluid supply device 102 operates to deliver a fluid under pressure to the waterblast tool 108 via a fluid hose 110. In some embodiments, the fluid supplied by the fluid supply device 102 is water. In other embodiments, the fluid supplied by the fluid supply device 102 is a mixture of water and one or more abrasive materials. An example of the fluid supply device 102 is described in more detail with reference to FIG. 2.

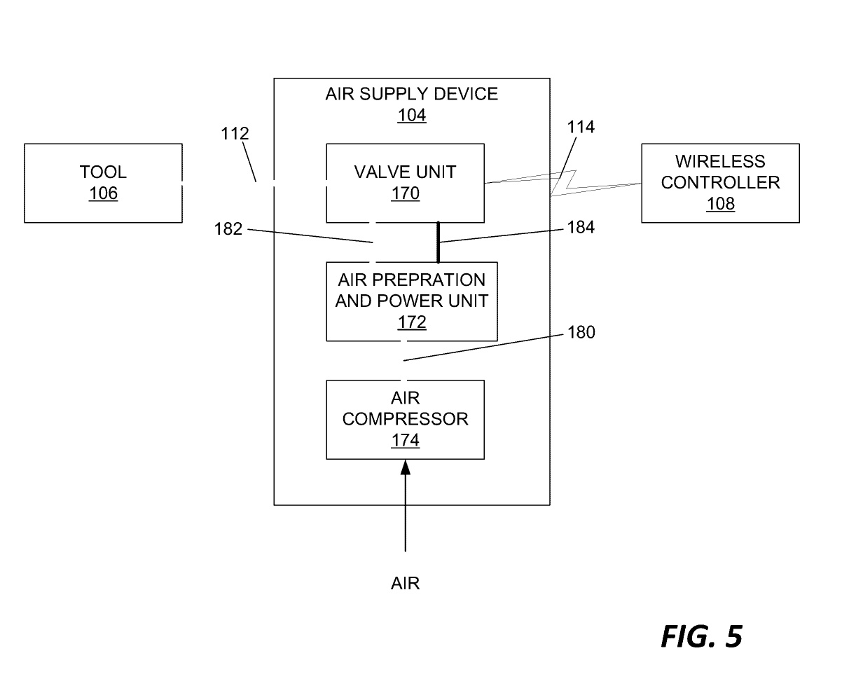

The air supply device 104 operates to supply compressed air to the waterblast tool 108 via an air cable 112. An example of the air supply device 104 is described in more detail with reference to FIG. 5.

The waterblast tool 106 is connected to the fluid supply device 102 via the fluid hose 110 and the air supply device 104 via the air cable 112. The waterblast tool 108 receives pressurized fluid and air from the fluid supply device 102 and the air supply device 104 in controlled manners, and injects either the pressurized fluid or the compressed air, and a mixture of the pressurized fluid and air to a surface or object.

Some examples of the waterblast tool 106 can be an automated tool that can be controlled via a controller or control station that is remotely located from the tool. In some embodiments, the wireless controller 108 is configured to provide an interface for an operator to control the tool 106, as well as the fluid supply device 102 and the air supply device 104. For example, the wireless controller 108 can provide an interface both for adjusting the position, location, length, orientation, angle, operational speed, duration, strength, and/or other operational factors of the tool 106, and for controlling the fluid supply device 102 and the air supply device 104 as described below. In other embodiments, an independent control device is provided for controlling the waterblast tool 106.

In other embodiments, the tool 106 does not need separate controlling. The tool 106 can be controlled by controlling the fluid supply device 102 and the air supply device 104. For example, where the tool 108 is installed in a fixed place and position, the tool 108 can be operated by controlling the fluid supply device 102 and the air supply device 104.

The waterblast tool 106 can be of various types. Examples of the waterblast tool 106 include (1) automated surface cleaning tools with (i) a rail and tractor system, (ii) a tractor, a drive rail, and a rotating waterblasting head, (iii) an air or hydraulic powered swivel unit, and/or (iv) a self-rotary cleaning head; (2) rotary shotgun cleaning tools, (3) concrete demolition systems, (4) automated floor cleaning tools with (i) paint grate cleaning tools or (ii) automated tube lancing systems, (5) exchanger cleaning tools, (6) straight pipe cleaning tools, (7) curved pipe cleaning tools, (8) tank and vessel cleaning tools, (9) furnace and boiler cleaning tools, and (10) rotary swivels, all of which are available by Jetstream of Houston, LLP.

The wireless controller 108 operates to wirelessly control the fluid supply device 102 and the air supply device 104. In some embodiments, the wireless controller 108 is used to wirelessly control both of the fluid supply device 102 and the air supply device 104. In other embodiments, the wireless controller 108 is used to further control the tool 106. The wireless controller 108 is connected to the fluid supply device 102 and the air supply device 104 via a network 114. The network 114 includes a wireless communication system. A wired communication system can transmit data using electrical or optical signals in various possible embodiments. Wireless communication systems typically transmit signals via electromagnetic waves, such as in the form of optical signals or radio frequency (RF) signals. A wireless communication system typically includes an optical or RF transmitter for transmitting optical or RF signals, and an optical or RF receiver for receiving optical or RF signals. The network 114 can include Wi-Fi communication devices, such as utilizing wireless routers or wireless access points. In other embodiments, the network 114 can be implemented with cellular communication devices (such as utilizing one or more cellular base stations) and/or other wireless communication devices.

The wireless controller 108 provides an interface through which a user interacts with the fluid supply device 102 and the air supply device 104. A user can use the wireless controller 108 to enter input for controlling the fluid supply device 102 and the air supply device 104 and monitor the operational status of the devices 102 and 104.

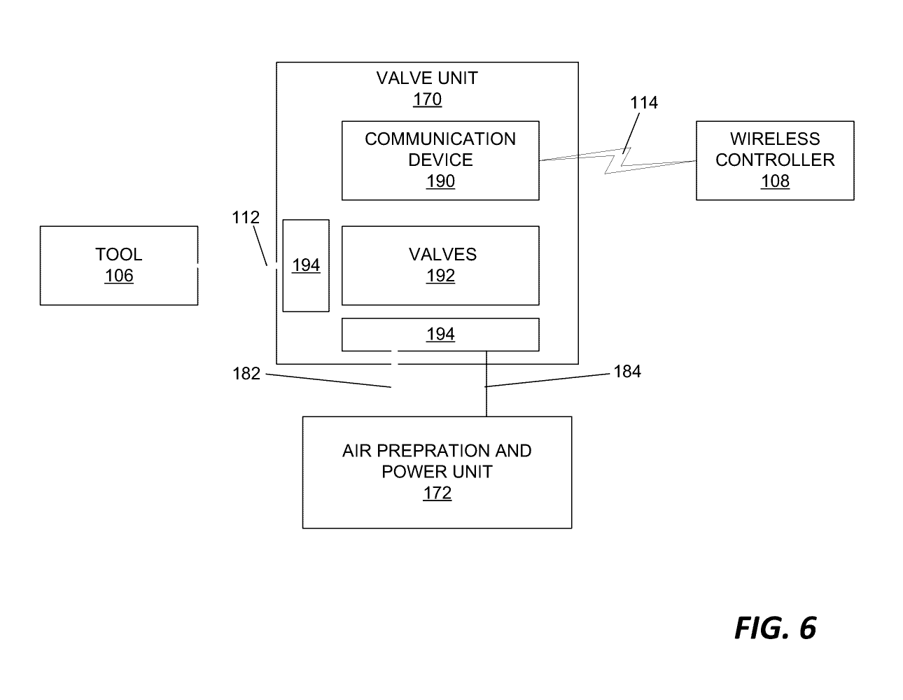

In some embodiments, the wireless controller 108 is configured with a portable computing device. In some embodiments, the wireless controller 108 is configured as a mobile computing device running an application that provides an interface for a user to control both of the fluid supply device 102 and the air supply device 104. The wireless controller 108 can be wirelessly connected to the fluid supply device 102 (e.g., a communication device 130 thereof (FIG. 2)) and the air supply device 104 (e.g., a communication device 190 thereof (FIG. 6), for example via a local wireless network or short-range wireless communication (e.g., Bluetooth). Alternatively, the wireless controller 108 can be connected to the fluid supply device 102 and the air supply device 104 through one or more wired communication interfaces.

The wireless controller 108 can be configured with one or more handheld mobile devices that are typically used for daily purposes, such as off-the-shelf smartphones, tablets, or PDAs. Such a wireless controller 108 can still be used for other purposes when it is not used with the waterblast system 100. The wireless controller 108 can alternatively configured to be dedicated to the waterblast system 100.

As such, a user can actuate and control the fluid supply device 102 and the air supply device 104 using the wireless controller 108 while being remotely present from the fluid supply device 102 and the air supply device 104. The user does not have to stay close to the fluid supply device 102, the air supply device 104, and the tool 106 when the waterblast system 100 is in operation. Therefore, the user can avoid harm and danger from a pressurized fluid from the fluid supply device 102, a compressed air from the air supply device 104, and a blast jet stream from the tool 106.

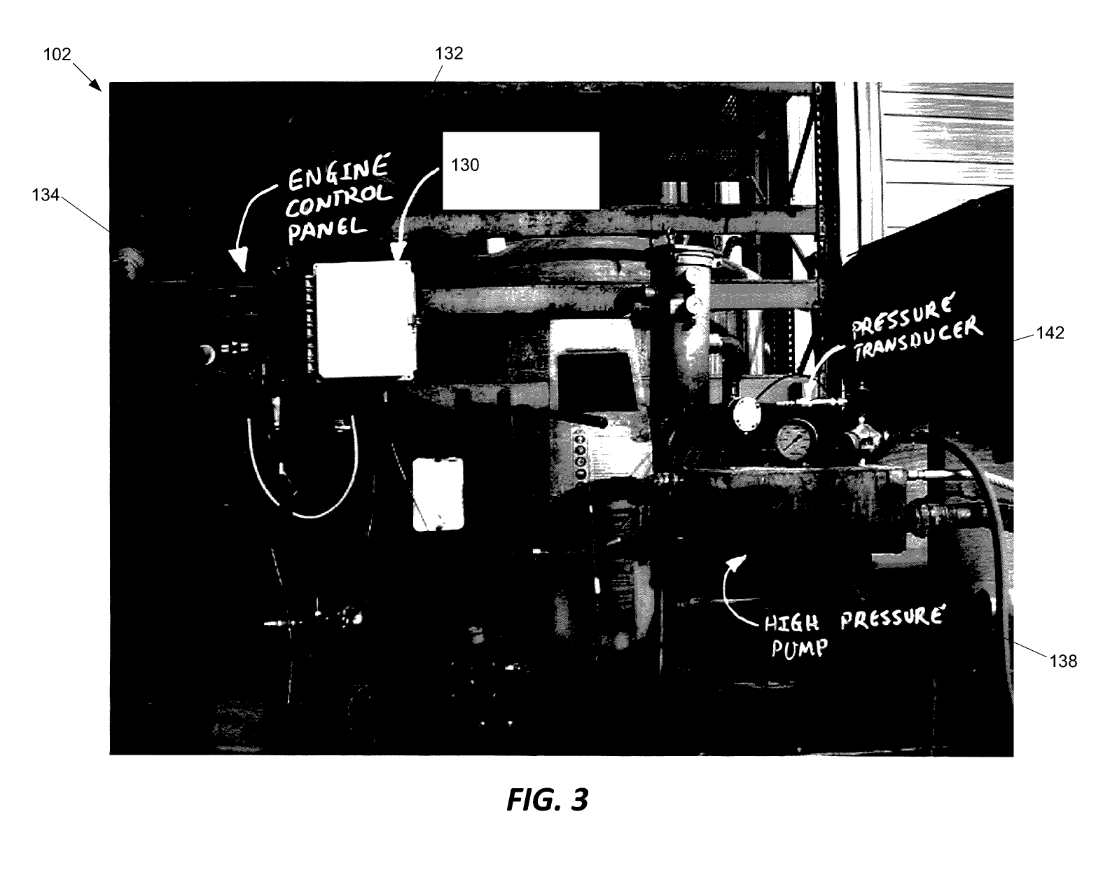

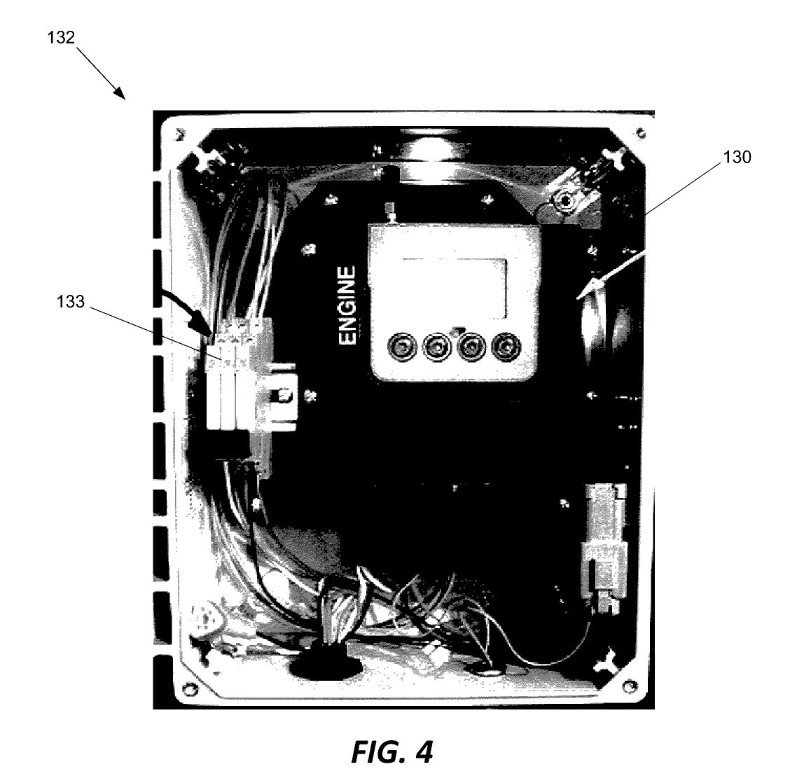

Referring to FIGS. 2-4, an example of the fluid supply device 102 is described. In particular, FIG. 2 schematically illustrates an example of the fluid supply device 102, FIG. 3 illustrates an example implementation of the fluid supply device 102, and FIG. 4 is an example configuration of a control device of the fluid supply device 102.

In this example, the fluid supply device 102 can include a communication device 130, a control device 132, an engine control panel 134, an engine 136, a fluid pump 138, a fluid tank 140, and a pressure sensor 142.

The communication device 130 operates to wirelessly communicate with the wireless controller 108. The communication device 130 receives data from the wireless controller 108. Such data can include information about user inputs or selections for controlling the fluid supply device 102. The communication device 130 can transmit data to the wireless controller 108. Such data can include information about the operational status of the fluid supply device 102, and can be displayed on the wireless controller 108. The communication device 130 is configured to establish wireless communication with the wireless controller 108 via a wireless local area network. Such wireless communication can be established in various manners, such as based on IEEE 802.11 standards.

The control device 132 includes control circuitry designed to control the engine 136 and/or the fluid pump 138. The control device 132 is operated based on a user input through the wireless controller 108. In addition, the control device 132 can also receive a user input through the control panel 134 and control the engine 136 and/or the fluid pump 138 based on the input.

The control panel 134 is included in the fluid supply device 102 and provides an interface for an operator to control the engine 136, the fluid pump 138, and other controllable components of the fluid supply device 102. In some embodiments, the control panel 134 is configured as an engine control panel, as shown in FIG. 3. In some embodiments, the control panel 134 includes a mechanical and/or electrical interface with analog input elements (e.g., analog buttons, control sticks, function keys, keypads, and switches) to receive a user's input or selection for various operations of the fluid supply device 102. The wireless controller 108 can include a display device for showing various pieces of information (e.g., operational status or user input) regarding the fluid supply device 102.

The engine 136 operates the fluid pump 138 to deliver pressurized fluid (e.g., water) to the tool 106. The engine 136 can be of any type, such as internal combustion engine and electric motor.

The fluid pump 138 operates to move fluid from the fluid tank 140 to the tool 106. In some embodiments, the fluid pump 138 is configured to pressurize the fluid from the fluid tank 140 and deliver the pressurized fluid to the tool 106.

The fluid tank 140 is configured to store fluid which is to be delivered to the tool 106. In some embodiments, the fluid tank 140 is included in the fluid supply device 108 as a unit. In other embodiments, the fluid tank 140 is placed or arranged separately from the fluid supply device 102 and connected to the fluid supply device 102 (e.g. the fluid pump 138) via a fluid hose.

In other embodiments, the fluid supply device 102 does not include the fluid tank 140, and instead has a direct hose connection to a water source. In this case, the fluid pump 138 receives fluid directly from the water source via a fluid hose.

The pressure sensor 142 operates to monitor fluid pressure at the fluid pump 138. The information about the fluid pressure monitored can be transmitted to the control device 132 and used to adjust controlling the engine 136 and/or the fluid pump 138.

With reference to FIG. 4, the control device 132 is associated with, or includes, the communication device 130. In some embodiments, the communication device 130 includes a radio frequency module. Further, the control device 132 can include one or more switching devices for various operations, such as for increasing and decreasing an engine speed and for emergency stop.

FIG. 5 schematically illustrates an example of the air supply device 104. The air supply device 104 includes a valve unit 170, an air preparation and power unit 172, and an air compressor 174.

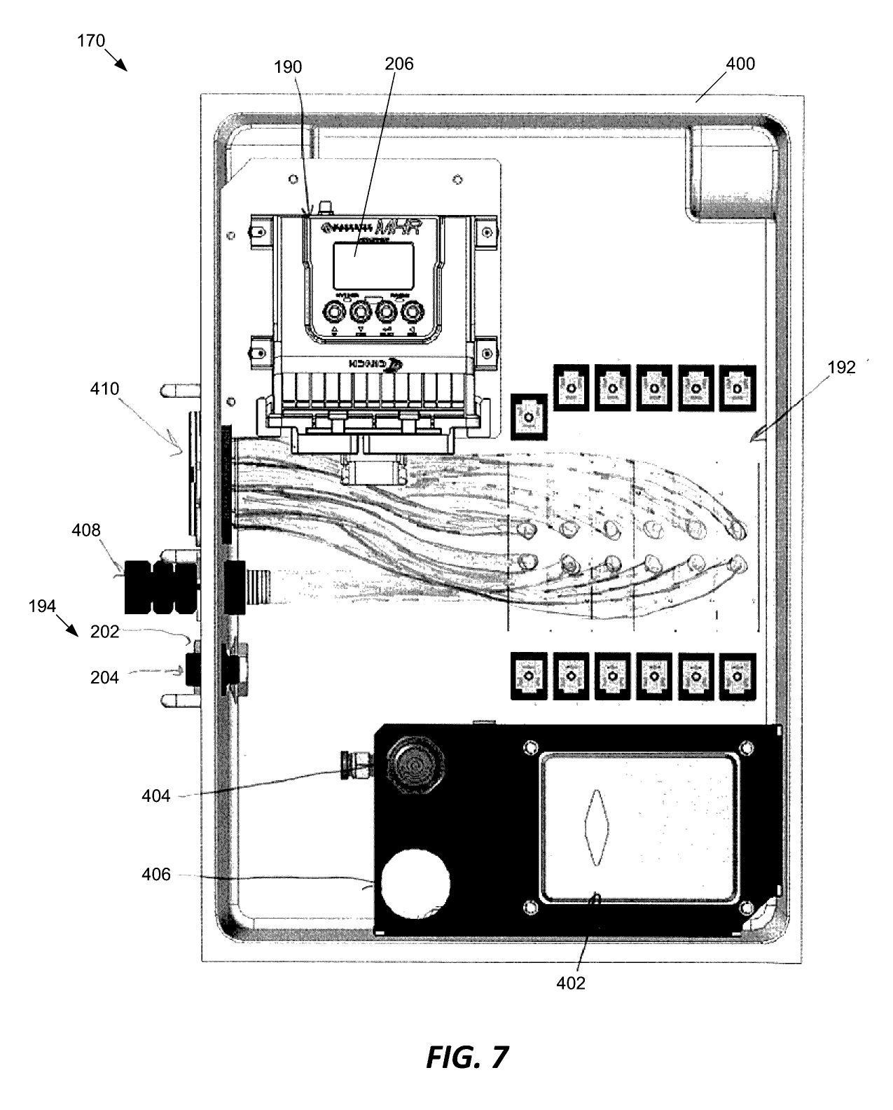

The valve unit 170 is configured to control delivery of compressed air to the tool 106. In this example, the valve unit 170 is controlled using the wireless controller 108 via the network 114. In some embodiments, the valve unit 170 is configured as a self-contained unit, which is separately movable from other components (e.g., the air preparation and power unit 172 and the air compressor 174) of the air supply device 104. Therefore, the valve unit 170 is easily transportable, as well as other separately configured components, such as the air preparation and power unit 172. The valve unit 170 can includes a frame, box, or cabinet 400 that can secure the components of the valve unit 170 as described in FIG. 7. An example of the valve unit 170 is described in more detail with reference to FIGS. 6 and 7.

The air preparation and power unit 172 operates to receive the compressed air from the air compressor 174 and prepare the air to be suitable for the tool 106. The air preparation and power unit 172 is pneumatically connected to the air compressor 174 and the valve unit 170 via air hoses 180 and 182. The air preparation and power unit 172 further operates to provide electric power to components of the air supply device 104. For example, the air preparation and power unit 172 are electrically connected to the valve unit 170 via a power cable 184, thereby supplying at least some of the generated electric power to the valve unit 170.

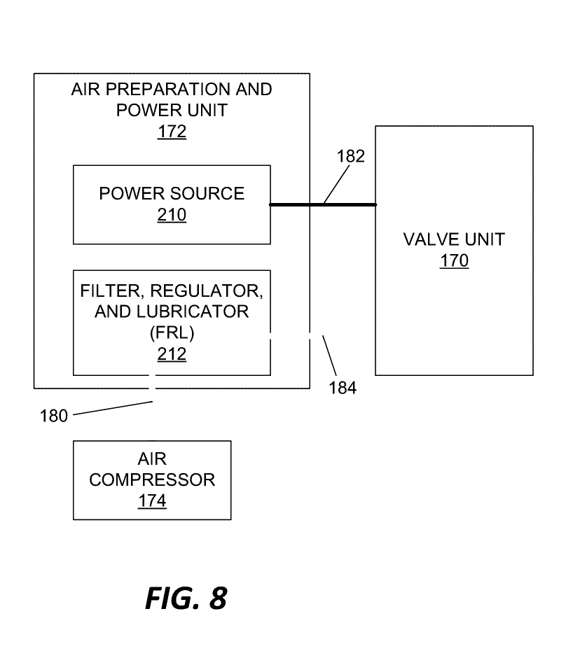

In some embodiments, the air preparation and power unit 172 is configured as a self-contained unit, which is separately movable from other components (e.g., the valve unit 170 and the air compressor 174) of the air supply device 104. Therefore, the air preparation and power unit 172 is easily transportable, as well as other separately configured components, such as the valve unit 170 as described above. The air preparation and power unit 172 can includes a frame, box, or cabinet that can secure the components of the air preparation and power unit 172 as described in FIG. 8. An example of the air preparation and power unit 172 is described in more detail with reference to FIG. 8.

In the illustrated example, it is primarily illustrated that the valve unit 170 and the air preparation and power unit 172 are separately configured and independently movable, it is also possible to include the valve unit 170 and the air preparation and power unit 172 in a same enclosure, frame, box, or cabinet.

The air compressor 174 operates to take in and compress air. In the illustrated example, the air compressor 174 is included in the air supply device 104. In other embodiments, the air compressor 174 is not contained in the air supply device 104, and can be located separately from the air supply device 104. In yet other embodiments, the air compressor 174 can be driven by the engine of the fluid supply device 102. In yet other embodiments, the air compressor 174 is included as a component of the fluid supply device 102.

Referring to FIGS. 6 and 7, an example of the valve unit is described. In particular, FIG. 6 schematically illustrates an example of the valve unit 170, and FIG. 7 is an example implementation of the valve unit 170. The valve unit 170 can include a communication device 190, one or more valves 192, and a quick disconnect (QD) couplings 194.

The communication device 190 operates to wirelessly communicate with the wireless controller 108. The communication device 190 receives data from the wireless controller 108. Such data can include information about user inputs or selections for controlling the valve unit 170. The communication device 190 can transmit data to the wireless controller 108. Such data can include information about the operational status of the valve unit 170, and can be displayed on the wireless controller 108. The communication device 190 is configured to establish wireless communication with the wireless controller 108 via a wireless local area network. Such wireless communication can be established in various manners, such as based on IEEE 802.11 standards.

The valves 192 are provided to selectively control flow of compressed air into the tool 106. The valves 192 are connected to the tool 106 via the air cable 112. The valves 192 are controlled based on user control inputs or selections which are entered via the wireless controller 108 and received by the communication device 190. In some embodiments, the valves 192 include directional valves. For example, each of the directional valves 192 includes a spool within a cylinder which is mechanically, hydraulically, or electrically actuated based on the user control inputs or selections via the wireless controller 108. The movement of the spool restricts or permits the flow of compressed air, thereby controlling delivery of compressed air to the tool 106. By way of example, the spool of the valve 192 is actuated using one or more solenoids. The position of the spool within the cylinder can be determined based on an amount of current supplied to the solenoids.

The quick disconnect couplings 194 are configured to connect and/or disconnect hydraulic or pneumatic lines quickly and easily without the use of tools. In this example, the quick disconnect couplings 194 are configured to conveniently connect and/or disconnect the air cable 112 for the tool 106. Further, the quick disconnect couplings 194 can be arranged to easily connect and/or disconnect the air cable 182 and the power cable 184 from the air preparation and power unit 172. Other configurations for fitting the air cable 182 and the power cable 184 are also possible in other embodiments.

With reference to FIG. 7, the valve unit 170 includes a frame or box 400 containing the components of the valve unit 170. As illustrated, the wireless communication device 190 can include a radio frequency (RF) module 206. In addition to the components of the valve unit 170 as described above, the valve unit 170 includes a speed control valve 402 including a pressure regulator 404 and a pressure gauge 406. The speed control valve 402 can operate to control a pressure of the compressed air flowing from the air compressor 174. The valve unit 170 further includes an air exhaust muffler 408 pneumatically connected to the valves 192. The valve unit 170 also includes a multiport air connector 410 pneumatically connected to the valves 192 within the valve unit 170 and configured to connect the air cable 112 for the tool 106.

FIG. 8 schematically illustrates an example of the air preparation and power unit 172. The air preparation and power unit 172 includes a power source 210 and a set of filter, regulator, and lubricator (FRL) 212.

The power source 210 operates to supply electric power to the valve unit 170 to actuate the components of the valve unit 170. In some embodiments, the power source 210 includes a battery. In other embodiments, the power source 210 includes an external power source, such as mains power system.

The FRL 212 operates to filter, regulate, and lubricate the compressed air from the air compressor 174. The FRL 212 is used to avoid damage of downstream equipment due to hot, dirty, and wet air flowing from the air compressor 174. For example, the filter of the FRL 212 operates to remove contaminants from the compressed air, preventing damage to equipment and reducing production losses due to contaminant related downtime. The pressure regulator of the FRL 212 operates to reduce and control fluid pressure in the compressed air. In particular, the pressure regulator of the FRL 212 maintains a constant output pressure regardless of variations in the input pressure and downstream flow requirements. The pressure regulator of the FRL 212 contributes to controlling of control pressure to the tool 106. The lubricator of the FRL 212 operates to add controlled quantities of oil into the compressed air to reduce the friction of moving components.

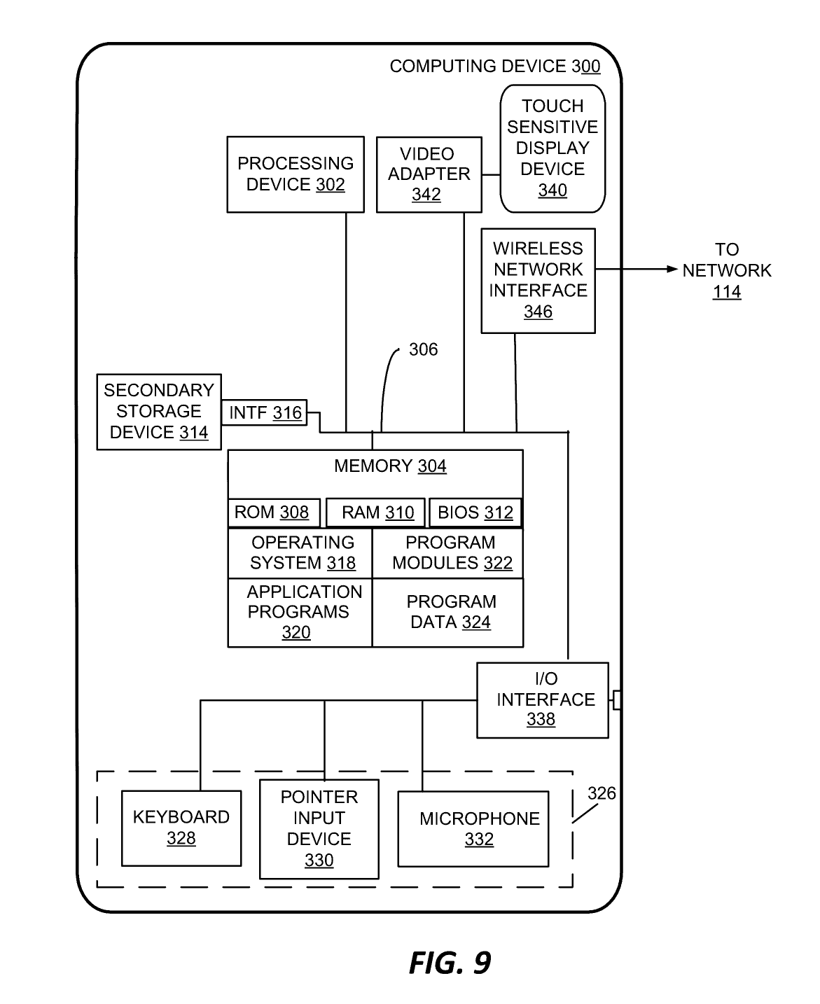

FIG. 9 illustrates an exemplary architecture of a computing device that can be used to implement aspects of the present disclosure, including the wireless controller 108, and will be referred to herein as the computing device 300. The computing device 300 is used to execute the operating system, application programs, and software modules (including the software engines) described herein.

The computing device 300 includes, in some embodiments, at least one processing device 302, such as a central processing unit (CPU). A variety of processing devices are available from a variety of manufacturers, for example, Intel or Advanced Micro Devices. In this example, the computing device 300 also includes a system memory 304, and a system bus 306 that couples various system components including the system memory 304 to the processing device 302. The system bus 306 is one of any number of types of bus structures including a memory bus, or memory controller; a peripheral bus; and a local bus using any of a variety of bus architectures.

Examples of computing devices suitable for the computing device 300 include a desktop computer, a laptop computer, a tablet computer, a mobile device (such as a smart phone, an iPod® mobile digital device, or other mobile devices), or other devices configured to process digital instructions.

The system memory 304 includes read only memory 308 and random access memory 310. A basic input/output system 312 containing the basic routines that act to transfer information within computing device 300, such as during start up, is typically stored in the read only memory 308.

The computing device 300 also includes a secondary storage device 314 in some embodiments, such as a hard disk drive, for storing digital data. The secondary storage device 314 is connected to the system bus 306 by a secondary storage interface 316. The secondary storage devices and their associated computer readable media provide nonvolatile storage of computer readable instructions (including application programs and program modules), data structures, and other data for the computing device 300.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media.

A number of program modules can be stored in secondary storage device 314 or memory 304, including an operating system 318, one or more application programs 320, other program modules 322, and program data 324.

In some embodiments, computing device 300 includes input devices to enable a user to provide inputs to the computing device 300. Examples of input devices 326 include a keyboard 328, pointer input device 330, microphone 332, and touch sensitive display 340. Other embodiments include other input devices 326. The input devices are often connected to the processing device 302 through an input/output interface 338 that is coupled to the system bus 306. These input devices 326 can be connected by any number of input/output interfaces, such as a parallel port, serial port, game port, or a universal serial bus. Wireless communication between input devices and interface 338 is possible as well, and includes infrared, BLUETOOTH® wireless technology, 802.11a/b/g/n, cellular, or other radio frequency communication systems in some possible embodiments.

In this example embodiment, a touch sensitive display device 340 is also connected to the system bus 306 via an interface, such as a video adapter 342. The touch sensitive display device 340 includes touch sensors for receiving input from a user when the user touches the display. Such sensors can be capacitive sensors, pressure sensors, or other touch sensors. The sensors not only detect contact with the display, but also the location of the contact and movement of the contact over time. For example, a user can move a finger or stylus across the screen to provide written inputs. The written inputs are evaluated and, in some embodiments, converted into text inputs.

In addition to the display device 340, the computing device 300 can include various other peripheral devices (not shown), such as speakers or a printer.

When used in a local area networking environment or a wide area networking environment (such as the Internet), the computing device 300 is typically connected to the network through a network interface, such as a wireless network interface 346. Other possible embodiments use other communication devices. For example, some embodiments of the computing device 300 include an Ethernet network interface, or a modem for communicating across the network.

The computing device 300 typically includes at least some form of computer-readable media. Computer readable media includes any available media that can be accessed by the computing device 300. By way of example, computer-readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 300.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The various examples and teachings described above are provided by way of illustration only and should not be construed to limit the scope of the present disclosure. Those skilled in the art will readily recognize various modifications and changes that may be made without following the example examples and applications illustrated and described herein, and without departing from the true spirit and scope of the present disclosure.

What is claimed is:

1. A waterblast system comprising:
a waterblast tool;
a fluid supply device configured to provide pressurized water to the waterblast tool;
an air supply device configured to provide compressed air to the waterblast tool; and
a wireless controller connected to the fluid supply device and the air supply device via network, the wireless controller configured to receive a user input for controlling the fluid supply device and the air supply device.

2. The waterblast system of claim 1, wherein the wireless controller includes a mobile computing device, the mobile computing device running an application that provides an interface for a user to provide the user input.

3. The waterblast system of claim 1, wherein the fluid supply device includes:
a fluid pump;
an engine adapted to operate the fluid pump;
a communication device configured to wirelessly communicate with the wireless controller and receive at least part of the user input from the wireless controller; and
a control device configured to control the engine based on the at least part of the user input.

4. The waterblast system of claim 3, wherein the control device includes an engine control panel providing an interface for a user to control the engine.

5. The waterblast system of claim 3, wherein the fluid supply device further includes a pressure sensor configured to detect a pressure at the fluid pump, and the control device receives data including the pressure and use the data for controlling the engine.

6. The waterblast system of claim 1, wherein the air supply device includes:
an air preparation and power unit providing pressurized air and generating electric power; and
a valve unit pneumatically and electrically connected to the air preparation and power unit, the valve unit configured to communicate with the wireless controller and control air flow to the waterblast tool based on at least part of the user input received from the wireless controller.

7. The waterblast system of claim 6, wherein the air preparation and power unit and the valve unit are separately configured and movable.

8. The waterblast system of claim 6, wherein the air supply device further includes an air compressor pressurizing air and supplying the pressurized air to the air preparation and power unit.

9. The waterblast system of claim 6, wherein the air preparation and power unit includes:
a filter, regulator, and lubricator unit for filter, regulate, and lubricate the pressurized air upstream of the valve unit; and
a power source configured to provide electric power to the valve unit.

10. The waterblast system of claim 6, wherein the valve unit includes:
a communication device configured to wirelessly communicate with the wireless controller and receive at least part of the user input from the wireless controller; and
one or more valves controlling flow of the pressurized air to the waterblast tool based on the at least part of the user input.

11. The waterblast system of claim 1, wherein the network includes a wireless local area network.
